(19) United States
(12) Patent Application Publication
(10) Pub. No.: US 2026/0225733 A1
(43) Pub. Date: Aug. 6, 2026

(54) Anomaly Prediction Using Images

(71) Applicant: The Boeing Company, Arlington, VA (US)

(72) Inventors: Esteban Fernando Lopez, St. Louis, MO (US); Peter Geoffrey Rhodes, Bridgeton, MO (US); Liessman Eric Sturlaugson, St. Louis, MO (US)

(21) Appl. No.: 19/320,156

(22) Filed: Sep. 5, 2025

Related U.S. Application Data
(60) Provisional application No. 63/754,875, filed on Feb. 6, 2025.

(51) Int. Cl. B64F 5/60; G06Q 10/20; G06T 7/00; G06V 10/77; G06V 10/82

(52) U.S. Cl. CPC B64F 5/60; G06Q 10/20; G06T 7/001; G06V 10/7715; G06V 10/82; G06T 2200/24; G06T 2207/20081; G06T 2207/20084; G06T 2207/30252

(57) ABSTRACT

A method predicts an anomaly. An input image of a platform selected for inspection is identified. An output image with a number of parameters predicted for the anomaly on the platform at a future time frame is generated using the input image of the platform, the future time frame, and an anomaly analysis system in response to identifying the input image. The anomaly analysis system comprises a machine learning model system configured to output images with the number of parameters predicted for anomalies on platforms at future time frames using inputs comprising input images of the platforms and the future time frames. A number of actions is performed based on the output image.

### CROSS-REFERENCE TO RELATED APPLICATION

This application claims the benefit of U.S. Provisional Patent Application Ser. No. 63/754,875, filed Feb. 6, 2025, and entitled “Anomaly Prediction Using Images,” which is incorporated herein by reference in its entirety.

### BACKGROUND INFORMATION

### 1. Field

The present disclosure relates generally to aircraft and in particular, to predicting anomalies in aircraft.

### 2. Background

Anomalies can appear on an aircraft over time. These anomalies can occur from various conditions such as exposure to the environment and stresses operating the aircraft over time. As an aircraft ages, anomalies can also arise from wear and tear. These anomalies can include cracks, corrosion, delamination, dents or other inconsistencies caused by foreign objects.

The presence of these anomalies can impact one or more of the structural integrity, aerodynamics and operating efficiency of the aircraft. As a result, inspections and maintenance are performed on a regular basis to detect and reduce the occurrence of anomalies.

In detecting anomalies on an aircraft, images are captured by sensor systems. These images can include infrared, camera, and ultraviolet images. These images can be used in computer vision and other image processing software to identify and classify anomalies such as cracks, dents, or corrosion.

### SUMMARY

An embodiment of the present disclosure

provides an anomaly prediction system comprising a computer system, an anomaly analysis system, and anomaly predictor in the computer system. The anomaly analysis system comprises a machine learning model system configured to output images with a number of parameters predicted for anomalies on platforms at future time frames using inputs comprising input images of the platforms and the future time frames. The anomaly predictor is configured to perform operations comprising identifying an input image of a platform selected for inspection; generating an output image with the number of parameters for an anomaly on the platform at a future time frame using the input image of the platform, the future time frame, and the anomaly analysis system in response to identifying the input image; and performing a number of actions based on the output image.

Another embodiment of the present disclosure provides an anomaly prediction system comprising a computer system, an anomaly analysis system in the computer system, and an anomaly predictor in the computer system. The anomaly analysis system comprises a machine learning model system configured to output images with a number of parameters predicted for anomalies on platforms at future time frames using inputs comprising input images of the platforms and future time frames. The anomaly predictor is configured to perform operations comprising identifying an input image of a platform selected for inspection and a threshold for an anomaly on the platform; selecting a future time frame for the anomaly; generating an output image with the number of parameters for the anomaly on the platform at the future time frame using the input image of the platform, the future time frame and the anomaly analysis system; determining whether the number of parameters in the output image meets a threshold; changing the future time frame to another future frame in response to the number of parameters not exceeding the threshold; repeating the generating, determining, and incrementing until the threshold is exceeded; and outputting the future time frame in response to the number of parameters not exceeding the threshold.

Yet another embodiment of the present disclosure provides a method for predicting an anomaly. An input image of a platform selected for inspection is identified. An output image with a number of parameters predicted for the anomaly on the platform at a future time frame is generated using the input image of the platform, the future time frame, and an anomaly analysis system in response to identifying the input image. The anomaly analysis system comprises a machine learning model system configured to output images with the number of parameters predicted for anomalies on platforms at future time frames using inputs comprising input images of the platforms and the future time frames. A number of actions is performed based on the output image.

Still another embodiment of the present disclosure provides a method for predicting an anomaly. An input image of a platform selected for inspection and a threshold for an anomaly on the platform are identified. A future time frame is selected for the anomaly. An output image with a number of parameters for the anomaly on the platform at the future time frame is generated using the input image of the platform, the future time frame and an anomaly analysis system. The analysis system comprises a machine learning model system configured to output images with the number of parameters predicted for anomalies on platforms using inputs comprising input images of the platforms and future time frames. Whether the number of parameters in the output image meets a threshold is determined. The future time frame is changed to another future frame in response to the number of parameters not exceeding the threshold. Generating, determining, and incrementing are repeated until the threshold is exceeded. The output image at the future time frame is output in response to the number of parameters not exceeding the threshold.

Another embodiment of the present disclosure provides a computer program product for predicting an anomaly. The computer program product comprises a set of one or more computer-readable storage media and program instructions stored on the set of one or more storage media. The program instructions are executed to perform operations comprising identifying an input image of a platform selected for inspection; generating an output image with a number of parameters predicted for the anomaly on the platform at a future time frame using the input image of the platform, the future time frame, and an anomaly analysis system in response to identifying the input image, wherein the anomaly analysis system comprises a machine learning model system configured to output images with the number of parameters predicted for anomalies on platforms at future time frames using inputs comprising input images of the platforms and the future time frames; and performing a number of actions based on the output image.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of

the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of an anomaly detection system of data processing systems in which illustrative embodiments may be implemented;

FIG. 2 is an illustration of a block diagram of an anomaly prediction environment in accordance with an illustrative embodiment;

FIG. 3 is an illustration of a block diagram of an anomaly analysis system in accordance with an illustrative embodiment;

FIG. 4 is an illustration of a training system to train a machine learning model to output images with parameters predicted for anomalies on platforms for future time frames in accordance with an illustrative embodiment;

FIG. 5 is an illustration of a dataflow of training in a segmentation model in accordance with an illustrative embodiment;

FIG. 6 is an illustration of using a segmentation model to generate an output image with a number of parameters predicted for an anomaly in accordance with an illustrative embodiment;

FIG. 7 is an illustration of using a segmentation model to generate an output image with a number of parameters predicted for an anomaly in accordance with an illustrative embodiment;

FIG. 8 is an illustration of passing data into a segmentation model in accordance with an illustrative embodiment;

FIG. 9 is an illustration of a generative artificial intelligence model used to generate an output image of a number of parameters predicted for an anomaly in accordance with an illustrative embodiment;

FIG. 10 is an illustration of images for an anomaly in accordance with an illustrative embodiment;

FIG. 11 is an illustration of a heat map of an aircraft in accordance with an illustrative embodiment;

FIG. 12 is an illustration of a flowchart of a process for predicting an anomaly in accordance with an illustrative embodiment;

FIG. 13 is an illustration of a flowchart of a process for generating output images from masks in accordance with an illustrative embodiment;

FIG. 14 is an illustration of a flowchart of a process for performing maintenance in accordance with an illustrative embodiment;

FIG. 15 is an illustration of a flowchart of a process for generating material performance data in accordance with an illustrative embodiment;

FIG. 16 is an illustration of a flowchart of a process for generating an output image in accordance with an illustrative embodiment;

FIG. 17 is an illustration of a flowchart of a process for displaying an output image in accordance with an illustrative embodiment;

FIG. 18 is an illustration of a flowchart of a process for training a machine learning model in accordance with an illustrative embodiment;

FIG. 19 is an illustration of a flowchart of a process for predicting an anomaly in accordance with an illustrative embodiment;

FIG. 20 is an illustration of a flowchart of a process for performing actions in accordance with an illustrative embodiment;

FIG. 21 is an illustration of a block diagram of a data processing system in accordance with an illustrative embodiment;

FIG. 22 is an illustration of a block diagram of an aircraft manufacturing and service method in accordance with an illustrative embodiment; and

FIG. 23 is an illustration of a block diagram of an aircraft in which an illustrative embodiment may be implemented.

### DETAILED DESCRIPTION

The illustrative embodiments recognize and take into account one or more different considerations as described herein. Machine learning models can be used to analyze images of an airplane. These machine learning models can detect anomalies. For example, the machine learning model such as a convolution on neural network (CNN) can be trained to analyze features such as texture, color changes, and patterns to detect and identify anomalies. These types of models can be trained using training data including examples of different types of anomalies.

However, current machine learning models do not provide for predicting changes or occurrences of anomalies at a future time from a current image of the aircraft. It would be desirable to have an anomaly detection system that can identify anomalies and predict how these anomalies change over time.

In the illustrative examples, an anomaly detection system identifies anomalies in an aircraft structure and predicts how these anomalies will change over time. These changes can be how an anomaly may grow in size, move, or propagate over time.

Further, the anomaly detection system can also make this prediction of future anomalies using physics data. This physics data can be obtained from physics models and may be used to estimate the growth of an inconsistency after a defined amount of use. This defined amount of time can be measured in a number of different ways. For example, the time can be measured in days, hours, a number of flight cycles, flight hours, time since last maintenance, or some other measure of time. Further, the knowledge detection system can also determine whether the anomaly at a future point in time will be within a tolerance. This anomaly detection system can also be used to determine whether an anomaly will develop even though one has not been detected in a current image of the aircraft. This knowledge can help determine when maintenance should be performed on the aircraft.

As used herein, “a number of” when used with reference to items, means one or more items. For example, “a number of flight cycles” is one or more flight cycles.

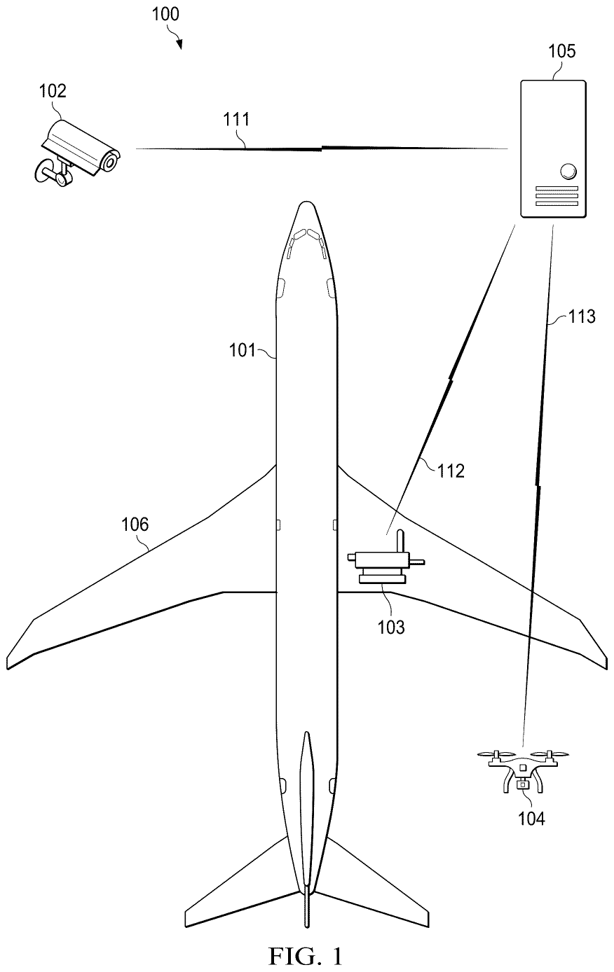

With reference now to the figures and, in particular, with reference to FIG. 1, a pictorial representation of an anomaly detection system of data processing systems is depicted in which illustrative embodiments may be implemented. In this illustrative example, anomaly prediction system 100 detects anomalies on airplane 101. In this example, this anomaly prediction system 100 can predict anomalies at a future point in time using current images generated for airplane 101.

As depicted in this example, anomaly prediction system 100 comprises camera 102, crawler 103, drone 104, and computer 105. In this example, camera 102, crawler 103, and drone 104 form a sensor system in which these components generate images of surface 106 of airplane 101.

Camera 102 is in a fixed location such as in a hangar bay, a maintenance building, or other suitable location where airplane 101 may be located. Crawler 103 moves on surface 106 of airplane 101. Drone 104 flies in locations relative to airplane 101.

Computer 105 is in communication with camera 102, crawler 103, and drone 104 using wireless communications links. For example, camera 102 has wireless communications link 111 with computer 105; crawler 103 has wireless communications link 112 with computer 105; and drone 104 has wireless communications link 113 with computer 105.

Camera 102, crawler 103, and drone 104 generate images of airplane 101. These images are sent to computer 105 over these wireless communications link connections for processing. In this illustrative example, computer 105 has a program code to process the images generated by these devices. For example, computer 105 is configured to predict the occurrence of anomalies or changes in anomalies at a future time frame from the current one in which the images are generated.

In this manner, the prediction of anomalies at a future time frame from current images can be used to determine when maintenance may be needed for airplane 101. Thus, maintenance can be performed in a manner that reduces the unavailability of aircraft when additional time is needed as compared to detecting anomalies a point in time in which maintenance is needed more quickly.

The illustration of anomaly prediction system 100 in FIG. 1 is one example of an anomaly detection system and is not meant to limit the manner in which other examples can be implemented. For example, in other illustrative examples only stick cameras and stationary positions may be present. In yet other examples, one or more drones in addition to drone 104 may be used with or without crawler 103 and camera 102.

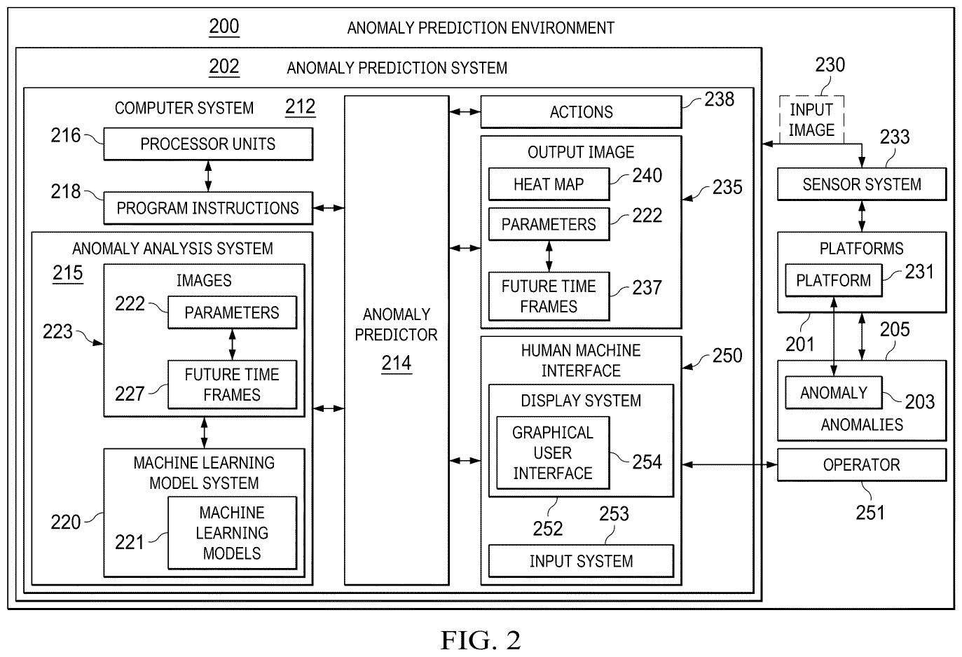

With reference now to FIG. 2, an illustration of a block diagram of an anomaly prediction environment is depicted in accordance with an illustrative embodiment. In this illustrative example, anomaly prediction environment 200 is an environment in which prediction of anomalies 205 on platforms 201 is performed using anomaly prediction system 202. Anomaly prediction system 100 in FIG. 1 is an example of an implementation for anomaly prediction system 202.

In this example, platform 231 in platforms 201 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, an unmanned aerial vehicle, an artificial intelligence controlled drone, a surface ship, a tank, a personnel carrier, a train, a spacecraft, a space station, a satellite, a high altitude platform system (HAPS), a submarine, an automobile, a power plant, a bridge, a dam, a house, a manufacturing facility, a building, and other types of platforms.

In this illustrative example, anomaly prediction system 202 comprises computer system 212, anomaly analysis system 215, and anomaly predictor 214. Anomaly analysis system 215 and anomaly predictor 214 are located in computer system 212.

Anomaly analysis system 215 includes machine learning model system 220. In this illustrative example, machine learning model system 220 is formed from a number of machine learning models 221. Machine learning model system 220 is configured to create images 223 with number of parameters 222 predicted for anomalies 205, at future time frames 227, using inputs comprising input images of platforms 201 and future time frames 227.

In this example, a future time frame can take a number of different forms. For example, the future time frame can be measured in hours, days, flight hours, a selected date in the future, engine cycles, flight cycles, and other measurements of time.

For example, each of the number of machine learning models 221 can be trained to output images with parameters 222 for anomalies 205 on platforms 201 for future time frames 227. Individual machine learning models may be trained to predict particular types of anomalies 205 as compared to other machine learning models in machine learning models 221.

Further, individual machine learning models can also be trained to output images with a number of parameters 222 predicted for anomalies 205 for specific future time frames. In other words, a particular machine learning model can be trained to generate an output images with a number of parameters 222 predicted for anomalies 205 for a future time frame such as 250 flight hours while another machine learning model can be trained to output images with a number of parameters 222 predicted for anomalies 205 for a future time frame such as 500 flight hours. In other cases, a machine learning model can be trained to yield output images with a number of parameters 222 predicted for anomalies 205 for ranges of future time frames 227.

In these illustrative examples, machine learning models 221 can be trained to output images with anomalies of different types. For example, an image can include a single type of anomaly or multiple types of anomalies depending on the particular training for a machine learning model.

The types of anomalies 205 can take a number of forms. For example, anomalies 205 can be selected from at least one of a corrosion, a crack, a delamination, a dent, pealed paint, buckling, desponding, oxidation, a pit, an abrasion, an impact inconsistency, a panel misalignment, or other types of anomalies.

In this illustrative example, the number of machine learning models 221 can take a number of different forms. These models can be all of the same type or different types of machine learning models when more than one machine learning model is present in the number of machine learning models 221. For example, the number of machine learning models 221 can select at least one of a segmentation model, a generative artificial intelligence model, a convolution on neural network (CNN), a fully convolutional neural network (CNN), a U-Net model, a DeepLab model, a support vector machine (SVM), or other suitable models that can be trained to perform segmentation functions such as classifying pixels in an image into categories. Models in machine learning models 221 are considered segmentation models even though their primary architecture may not be for classifying pixels in an image into specific categories. These models are considered segmentation models because they can be trained to perform segmentation functions such as classifying pixels in an image into categories.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Anomaly predictor 214 can be implemented in software, hardware, firmware or a combination thereof. When software is used, the operations performed by anomaly predictor 214 can be implemented in program instructions configured to run on hardware, such as a processor unit. When firmware is used, the operations performed by anomaly predictor 214 can be implemented in program instructions and data and stored in persistent memory to run on a processor unit. When hardware is employed, the hardware can include circuits that operate to perform the operations in anomaly predictor 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

Anomaly predictor 214 can identify an input image 230 of platform 231 in platforms 201 selected for inspection. In this example, input image 230 can be identified by being received from sensor system 233. Sensor system 233 is configured to generate input image 230. Sensor system 233 can be comprised of at least one of a camera, a visible light camera, a thermal imaging camera, an ultraviolet light camera, a hyperspectral camera, a laser scanner, or other type of sensor that can generate an image.

Further in this example, input image 230 can take a number of different forms. For example, input image 230 can be selected from a group comprising a visible light image, an infrared image, an ultraviolet lights image, a synthetic aperture radar image, a three dimensional image, and other suitable types of images that can be processed to generate output images with a number of parameters 222 predicted for anomalies 205.

Anomaly predictor 214 generates output image 235 with the number of parameters 222 predicted for anomaly 203 on platform 231 at future time frame 237 using the input image 230 of platform 231, future time frame 237, and anomaly analysis system 215 in response to identifying input image 230. Output image 235 can take a number different forms. For example, output image 235 can be selected from a group comprising a mask, a color image, a grayscale image, and other suitable types of images.

In this illustrative example, the number of parameters 222 can describe at least one of a size, a shape, dimensions, an aspect ratio, an orientation, a location, or other information about anomaly 203. In this example, size can be represented as an area. The number of parameters 222 can be used to identify at least one of a growth, change in shape, an expansion, or a movement of anomaly 203.

In some illustrative examples, input image 230 does not show a presence of anomaly 203. Anomaly 203 can develop at future time frame 237 and be visible in output image 235. In other illustrative examples, input image 230 shows anomaly 203 and output image 235 shows a change in anomaly 203.

In the illustrative examples, anomaly predictor 214 can generate output image 235 with the number of parameters 222 predicted for anomaly 203 on platform 231 for a number of future time frames 227 using input image 230 of platforms 201, the number of future time frames 227, and anomaly analysis system 215. In this example, output image 235 provides a visualization of the number of parameters 222 predicted for anomaly 203 for the number of future time frames 227.

In another example, output image 235 provides a visualization of anomaly 203 based on probabilities for anomaly sizes.

Anomaly predictor 214 performs a number of actions 238 based on output image 235. In this illustrative example, the number of actions 238 comprises at least one of storing the output image 235, generating an alert in response to output image 235 for the number of parameters 222 predicted for anomaly 203 at future time frame 237 being out of a tolerance, scheduling maintenance for the platform 231, displaying output image 235, or sending an email message with output image 235, or other suitable actions.

The particular action performed can depend on whether anomaly 203 is out of tolerance. The tolerance can be determined based on specifications, regulations, or other guidelines governing anomalies on platform 231, such as an aircraft.

In displaying output image 235, anomaly predictor 214 can display output image 235 on human machine interface 250. In this illustration, human machine interface (HMI) 250 is an interface system that can be used by operator 251 to interact with different components in computer system 212. As depicted, human machine interface 250 comprises display system 252 and input system 253.

Display system 252 is a physical hardware system and includes one or more display devices on which graphical user interface 254 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

Operator 251 is a person that can interact with graphical user interface 254 through user input generated by input system 253 for computer system 212. Input system 253 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device.

In another illustrative example, anomaly predictor 214 predicts the number of parameters 222 for a number of anomalies 205 in addition to anomaly 203 to form a plurality of anomalies 205 for future time frame 237. In this example, output image 235 is a heat map indicating locations of the plurality of anomalies 205 at future time frame 237. The plurality of anomalies 205 can be visualized in locations on platforms 201 in output image 235.

In another illustrative example, anomaly predictor 214 predicts the number of parameters 222 for a number of anomalies 205 in addition to anomaly 203 to form a plurality of anomalies 205 for future time frame 237. With this example, output image 235 is a heat map indicating a size of each of a plurality of anomalies 205 at future time frame 237.

In this illustrative example, the different operations performed to generate output image 235 with the number of parameters 222 can be used in practical application with respect to platform 231. For example, the practical application of these operations performed by anomaly predictor 214 can be the performance of maintenance on platform 231. The practical application of performing maintenance can include at least one of a human operator or a robotic system performing maintenance on platforms 201. In other examples, this practical application can include scheduling the maintenance. For example, operator 251 can schedule maintenance for platform 231 in response to viewing output image 235 displayed in graphical user interface 254 in display system 252.

Thus, the predictions for future states of anomalies at future time frames can be used to schedule maintenance on aircraft or other platforms. These predictions can determine when maintenance is needed accurately and with more fidelity as compared to normal maintenance schedules. As a result, less unexpected maintenance may be incurred with these more accurate predictions of parameters for anomalies at future states. As a result, the illustrative examples provide a practical application for predicting future states of anomalies.

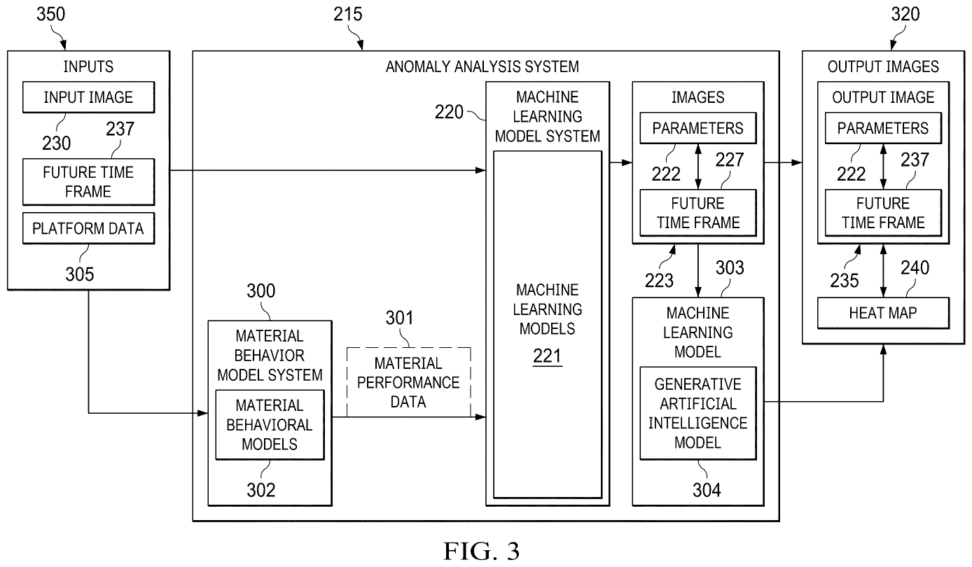

Turning to FIG. 3, an illustration of a block diagram of an anomaly analysis system is depicted in accordance with an illustrative embodiment. In the illustrative examples, the same reference numeral may be used in more than one figure. This reuse of a reference numeral in different figures represents the same element in the different figures.

As depicted, anomaly analysis system 215 receives input image 230 and future time frame 237 as inputs 350 to generate output image 235 with a number of parameters 222 predicted for platform 231 at future time frame 237. As depicted, these inputs are sent to machine learning model system 220 in anomaly analysis system 215.

As depicted, anomaly analysis system 215 can also include material behavior model system 300. In this example, material behavior model system 300 is configured to receive platform data 305 in inputs 350 and output material performance data 301 that is an input to machine learning model system 220. Platform data 305 is information about a platform. This information can be comprised of measurements made by sensors for the platform or the environment around the platform. Further, this information can also include service information about the operation of the platform.

For example, platform data 305 comprises at least one of weather data, platform telemetry, temperature, a pressure, an acceleration, an engine temperature, a hydraulic pressure, a vibration, a tail number, maintenance data, a pilot identification, flight hours, engine cycles, flight cycles, route information, maintenance history, component removal history, a compliance record, or other suitable information with respect to the history for platforms 201.

As depicted, material behavior model system 300 comprises a number of material behavioral models 302. These material behavior models can be implemented using a number of different types of models. For example, material behavioral models 302 can be selected from at least a physics based model, a chemical reaction model, an empirical model showing relationships from observations, program code implementing equations, a finite element analysis model, a machine learning model, or other suitable models.

For example, these material behavioral models can generate material performance data 301 in a number of different forms. For example, material performance data 301 can be selected from at least one of corrosion expansion data, oxidation, creep, total bending load, crack propagation, air resistance on surface, strain on a component, stress on a component, material degradation data, thermal degradation, chemical interaction data, cumulative stress over time, or other information. In this illustrative example, machine learning model system 220 can also be input into machine learning model system 220.

In this illustrative example, machine learning model system 220 can also receive platform data 305 in inputs 350. In some illustrative examples, images 223 are output images 320. Output image 235 is an example of an output image in output images 320. In other illustrative example, images 223 output by machine learning model system 220 can be processed to form output images 320.

For example, machine learning model 303, such as generative artificial intelligence model 304, can be configured to create output images 320 from images 223 output by the machine learning model system 220.

For example, images 223 can take the form of masks. A mask is a type of image in which the pixels are binary, such as either 0 or 1 in which areas with anomalies are white and areas without anomalies are black. In other examples, areas with anomalies can be black while areas without anomalies can be white. This type of image is also referred to as a segmentation mask.

With this example, generative artificial intelligence model 304 is configured to create the output image from the mask output by the machine learning model system 220. Output image 235 can be, for example, a color image.

In one illustrative example, output image 235 can be in the form of heat map 240. For example, heat map 240 can indicate the size of the anomaly for different probabilities. For example, a machine learning model in machine learning models 221 can determine the anomaly size for different probabilities for the future time frame. These probabilities for the area are shown in output image 235 in the form of heat map 240. Heat map 240 can be multiple areas of different sizes for an anomaly in a future time frame. These areas can be identified by colors in which each color for an area in heat map 240 indicates the probability that the anomaly will have that area. In heat map 240, each probability can have a different color and cover a different area in the output image.

The different components and inputs used by the anomaly analysis system are provided as an example and are not meant to limit the manner in which other illustrative examples can be implemented. For example, other types of inputs can also be used in inputs 350. For example, inputs 350 can also include at least one of an anomaly type, an anomaly size at a time of the image, an anomaly location, or other suitable inputs.

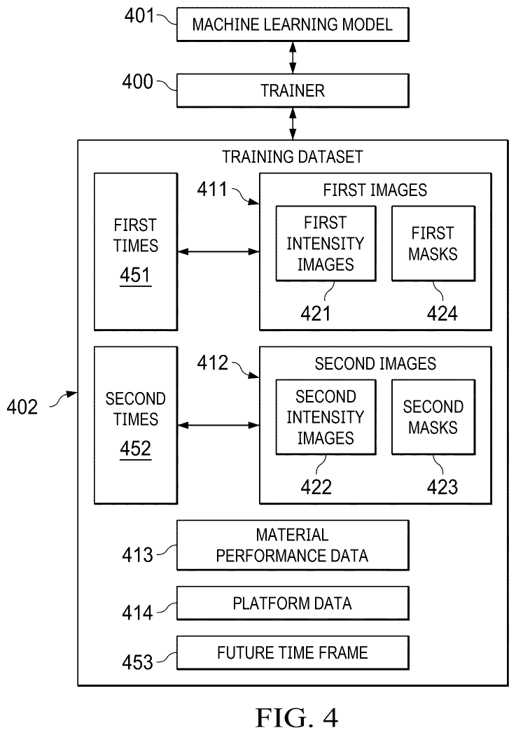

Turning next to FIG. 4, an illustration of a training system to train a machine learning model to output images with parameters predicted for anomalies on platforms for future time frames is depicted in accordance with an illustrative embodiment. In this illustrative example, trainer 400 operates to train a machine learning model 401. Trainer 400 can be software that runs any computer system such as computer system 212 in FIG. 2. Machine learning model 401 is an example of a machine learning model in machine learning models 221 in machine learning model system 220 in FIG. 2.

Training machine learning model 401 is performed using training dataset 402. In this illustrative example, trainer 400 identifies first images 411 of locations at first times 451 on a test platform. These first images are the images input into machine learning model 401 during training. Trainer 400 identifies second images 412 of the locations at second times 452 on the test platform in which a number of anomalies are present. The second images are the images used for comparison to images output by machine learning model 401 to determine the difference or error between the images.

In this example, second times 452 are later time frames than first times 451. For example, first image is present in first images 411 for a location at a first time frame in first times 451. A second image is present in second images 412 for the same location at a second time frame in second times 452. With this example, a first image corresponds to the second image because these images are images of the same location. The first time frame is an earlier time frame than the second time frame for these corresponding images.

In this example, first times 451 and second times 452 can also be included in training dataset 402. These times can be labels for first images 411 and second images 412.

Further, anomalies may not be present in first images 411 of the location but develop and appear in second images 412. In this example, trainer 400 forms training dataset 402 using first images 411 and second images 412.

In this illustrative example, first images 411 and second images 412 can take a number of different forms. For example, first images 411 can be first intensity images 421 which can be color images or grayscale images. Second images 412 can be second intensity images 422 or second masks 423. Second images 412 can be at least one of second intensity images 422 or second masks 423 with anomalies corresponding to those in first intensity images 421. In other words, both an intensity image and a mask can be present at the same time in second images 412.

Further, when second masks 423 are present in second images 412 with second intensity images 422, first masks 424 can also be present with first intensity images 421 in first images 411. With this example, first masks 424 have anomalies that correspond to any anomalies present in first intensity images 421. In some examples, an anomaly may not be present in these input images.

In the illustrative example, training dataset 402 can be data in addition to the images. For example, training dataset 402 can also include at least one of material performance data 413 or platform data 414. This data can also be selected for first times 451 and second times 452.

This additional data can be used for training with the images in a number of different ways. For example, labels can be used with the images and the additional data to correlate this information with each other for training machine learning model 401. In other examples, the images and the additional input data can be associated with each other by inputting this information at the same time into machine learning model 401. For example, a first image at time x, material performance data 413 at time X, and platform data 414 at time X can be input into machine learning model 401 at the same time. This machine learning model can concatenate this data together for processing to generate an output image that is compared to the second image at time X.

In this example, trainer 400 trains machine learning model 401 using training dataset 402. The training can be deep learning in which machine learning model 401 is trained to predict a mask which mimics the anomaly in some future state at a future time frame. This type of learning enables training off of the outputs of machine learning model 401, providing a “natural” means of answering the question. For example, the questions can be: what is the probability the defect will grow/shrink in N days?

In another example, machine learning model 401 in the form of a generative artificial intelligence model can be trained to answer questions such as what will the corrosion look like in two years? In response, this model can provide an image that is a visual representation of the future state of the corrosion. This image can then be analyzed for a number of parameters for the corrosion. These and other types of training techniques and machine learning models can be used to predict the future status of anomalies at future time frames.

In still another example, the future time frames can be flight hours. With this type of training, training dataset 402 comprises input images at a time frame of time X, output masks at time Y, and flight hours between corresponding pairs of input images and ground truth from time X to time Y. In this example, time X is a reference time frame and time Y is a future time frame for some number of flight hours between the reference time frame and the future time frame.

With this example, an input image at time X is input into a vision embedding layer in the machine learning model 401. Flight hours for this input image are normalized between 0 and 1. The normalized flight hours are concatenated with an output of image embedding layers. The concatenated vector is passed through the remaining portion of the model to receive an output mask for time Y. The output mask is compared to the corresponding ground truth mask for time Y. A loss is determined and machine learning model 401 is updated to reduce loss. This process is repeated using the different input images and ground truth mask pairs.

The illustration of training machine learning model 401 in FIG. 4 is provided as an example and is not meant to limit the manner in which training is implemented in other illustrative examples. For example, rather than defining time frames by timestamps such as first times 451 and second times 452, future time frame 453 can be used in training dataset 402 and can be a time period that indicates the future time frame from first image in first images 411 to the second image in second images 412.

In one illustrative example, one or more technical solutions are present that overcome a technical problem with anomalies that may occur on platforms at future time frames. As a result, one or more technical solutions may provide a technical effect enabling the prediction of anomalies on a platform at a future time frame using images from a prior time frame. An input image of the platforms is identified and an output image is generated using the input image and anomaly analysis system. This anomaly analysis system includes a machine learning model system that predicts one or more parameters for anomalies on platforms using the input images and future time frames. This anomaly analysis system generates output images with the parameters for the anomalies.

Computer system 212 can be configured to perform at least one of the steps, operations, or actions described in the different illustrative examples using software, hardware, firmware or a combination thereof. As a result, computer system 212 operates as a special purpose computer system in which anomaly predictor 214 in computer system 212 enables computer system 212 to be able to predict parameters for anomalies on a platform at a future time frame using an image from an earlier time frame. In particular, anomaly predictor 214 transforms computer system 212 into a special purpose computer system as compared to currently available general computer systems that do not have anomaly predictor 214.

In the illustrative example, the use of anomaly predictor 214 in computer system 212 integrates processes into a practical application performing maintenance on platforms such as aircraft. The maintenance can be more accurately scheduled than performed using these predictions of parameters for anomalies and output images generated by computer system 212 and in particular, computer system 212 using anomaly predictor 214.

The illustration of anomaly prediction environment 200 and the different components in FIGS. 2-4 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, anomalies can be identified by anomaly predictor 214 locating input image 230 in a database instead of receiving this image sensor system 233. In another illustrative example, output image 235 generated by anomaly analysis system 215 can include one or more types of anomalies in addition to or in place of anomaly 203 in which these anomalies can be different types of anomalies.

Further, in some cases the anomalies may be of the same type, but the locations are far enough apart to be considered different anomalies of the same type. For example, an anomaly can be corrosion on a wing panel and another anomaly can be corrosion on a fuselage of an aircraft.

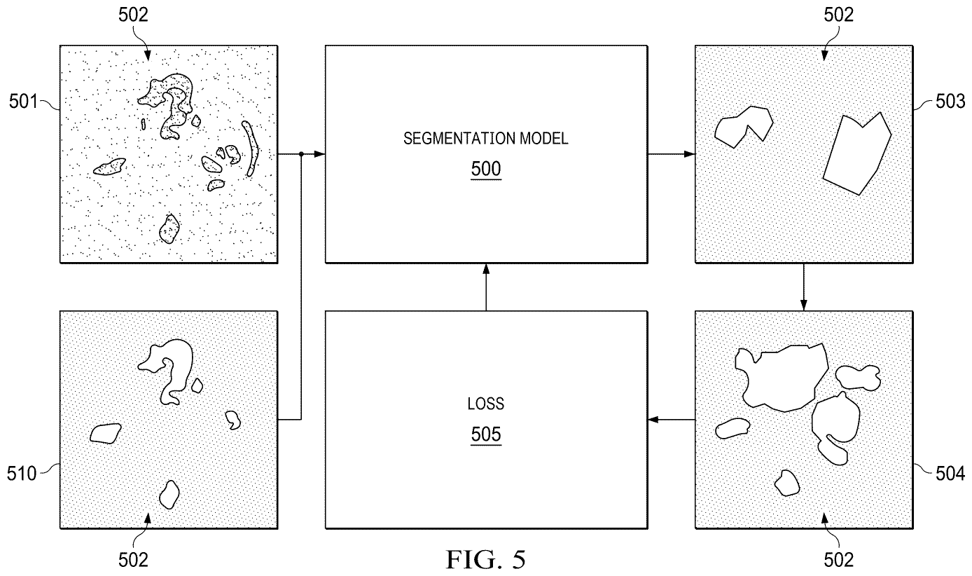

Turning next to FIG. 5, an illustration of a dataflow for training in a segmentation model is depicted in accordance with an illustrative embodiment. In this illustrative example, segmentation model 500 is trained using trainer 400 in FIG. 4. Different operations described in this dataflow are performed by trainer 400 in FIG. 4. Segmentation model 500 is an example of a machine learning model in machine learning models 221 in machine learning model system 220 in FIG. 3.

As depicted, input intensity image 501 contains anomaly 502. In these examples, an intensity image is a color image, a grayscale image, or some other type of image that has multiple intensities to represent an object. Intensity images are different from a mask which uses binary values in which one logic value is used to indicate an absence of an anomaly in the pixel and another logic value is used to indicate the presence of an anomaly in the pixel.

Additionally, input mask 510 can also be used as an input into segmentation model 500 for training. In this example, input mask 510 includes anomaly 502 in the same time frame as input intensity image 501.

In response to receiving input images such as input intensity image 501 and input mask 510, segmentation model 500 predicts changes in pixels that correspond to changes in parameters for anomaly 502 for a future time frame. As depicted, segmentation model 500 outputs an image in the form of output mask 503.

As depicted, output mask 503 is a mask that indicates a number of parameters predicted for anomaly 502 at a future time frame. This mask depicts a number of parameters predicted for anomaly 502 at a future time frame from input intensity image 501 and input mask 510. In other words, output mask 503 can provide a visualization of changes in one or more parameters of anomaly 502 at the future time frame. In this example, the number of parameters can be the area and shape for anomaly 502 at the future time frame.

Output mask 503 is compared to ground truth mask 504, which is a mask identifying the actual area and shape for anomaly 502. Output mask 503 is compared to ground truth mask 504 to determine the difference between these two images. Loss 505 is calculated using the difference between these two masks.

A number of different functions can be used to calculate loss 505. For example, loss 505 can be calculated using a loss function such as Mean Squared Error (MSE) and Cross-Entropy Loss.

Loss 505 is then used to update segmentation model 500. Different weights and other parameters can be adjusted in segmentation model 500 to reduce the difference between an output image and a ground truth image in future training iterations.

The illustration of the dataflow to train segmentation model 500 is an example of one manner in which a machine learning model can be trained to output images with a number of parameters predicted for anomalies on a platform. This illustration is not meant to limit the manner in which other illustrative examples can be implemented for training. For example, a future time frame may be input into segmentation model 500 as part of the training process. In yet other illustrative examples, other inputs such as material performance data and platform data can also be input. In yet other examples, another type of machine learning model such as a generative artificial intelligence model outputs an intensity image in place of output mask 503 and ground truth mask 504 can be a ground truth intensity image.

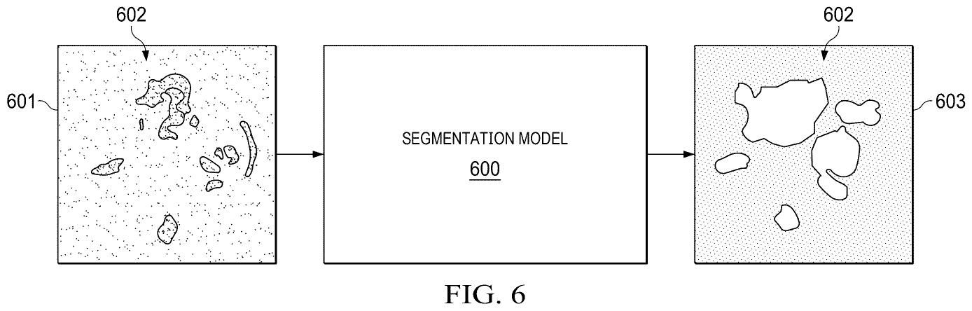

Turning to FIG. 6, an illustration of using a segmentation model to generate an output images with a number of parameters predicted for an anomaly is depicted in accordance with an illustrative embodiment. In this illustrative example, segmentation model 600 receives input image 601 at first time frame. Segmentation model 600 is an example of a segmentation model trained by trainer 400 in FIG. 4.

In this example, input image 601 contains anomaly 602. Segmentation model 600 outputs output image 603 at a future time frame from the first time frame. This output image shows anomaly 602 with a number of parameters predicted for this anomaly at the future time frame.

Next in FIG. 7, another illustration of using a segmentation model to generate an output image with a number of parameters predicted for an anomaly is depicted in accordance with an illustrative embodiment. Segmentation model 700 is an example of a segmentation model trained by trainer 400 in FIG. 4.

In this illustrative example, segmentation model 700 receives input intensity image 701 and input mask 702 at a first time frame. In this example, input intensity image 701 and input mask 702 contains anomaly 703. In response, segmentation model 700 outputs output mask 704 with anomaly 703 having changes in the number parameters as compared to the number parameters for anomaly 703 in input intensity image 701.

In one illustrative example, segmentation model 700 outputs output intensity image 705 instead of output mask 704, which is input intensity image 701 with outline 706. This outline has the same area as identified for anomaly 703 in output mask 704 and indicates the change in the number parameters for anomaly 703. In another example, segmentation model 700 outputs output mask 704.

Postprocessing can be performed to identify the area and shape of the anomaly within output mask 704 for an overlay of that area on input intensity image 701 with anomaly 703 with the number of parameters before the change at the future time frame.

In yet another illustrative example, output intensity image 707 is generated using output mask 704. In this example, generative artificial intelligence model 708 has been trained to generate pixel data for pixels within output mask 704 to provide a visualization of anomaly 703 in place of white pixels in output mask 704. In other words, generative artificial intelligence model 708 produces a visualization in output intensity image 707 of what anomaly 703 looks like at a future time frame within the bounds of output mask 704.

In this illustrative example, other inputs can also be used in addition to input intensity image 701 and input mask 702. For example, material performance data 711 is an example of another input that can be sent into segmentation model 700 in generating output mask 704. In this example, material performance data 711 is generated by material behavior model system 710 using platform data 712.

Additionally, platform data 712 can be processed by preprocess 713 to form preprocessed data 714 that is sent into material behavior model system 710 to generate material performance data 711. In this example, processing performed by preprocess 713 can include at least one of cleaning, transforming, structuring, and performing other operations on platform data 712. This processing can be performed to provide platform data 712 used by material behavior model system 710. This preprocessing can include principal component (PCA) analysis, scaling, normalizing with distribution coefficients of data, and other types of preprocessing.

Further, segmentation model 700 can directly receive platform data 712 in addition to or in place of material performance data 711. The use of this additional data may help improve the prediction of changes in the number of parameters for anomalies.

In this illustrative example, input intensity image 701 can be used with one or more of output mask 704, output intensity image 705, and output intensity image 707 to generate various metrics. These metrics can be generated by an anomaly predictor such as anomaly predictor 214 in FIG. 2. For example, metrics such as percentage growth from the time frame of input intensity image 701 to the future time frame for output mask 704 can be used. Other metrics can include determining a change in size, severity, shape, location, or other information regarding the change in the number parameters for the anomaly at the future time frame.

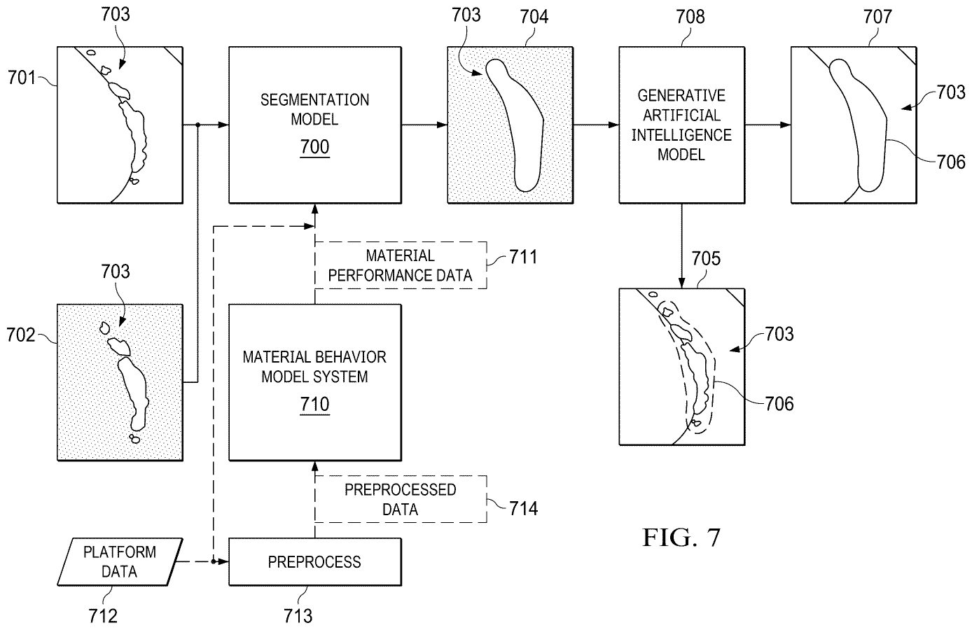

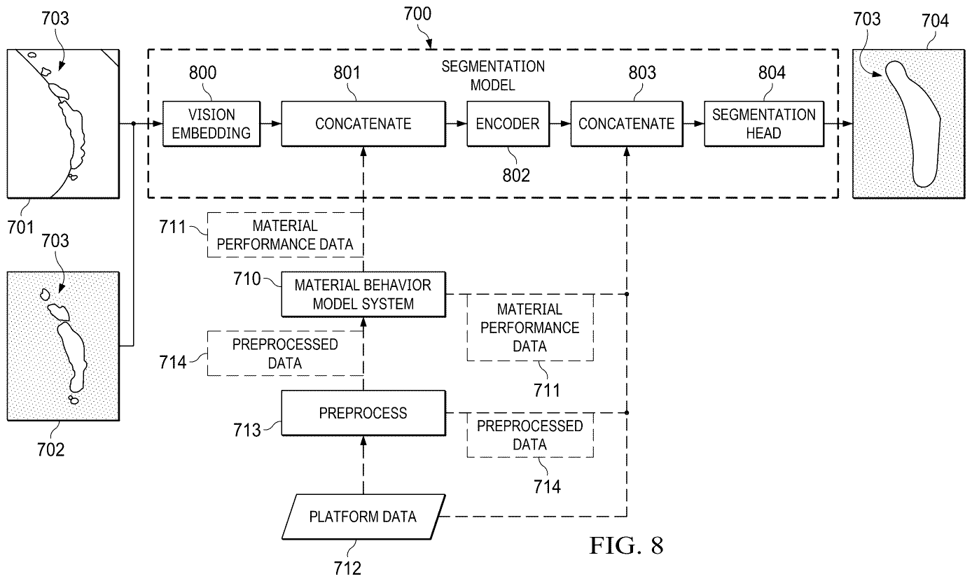

Turning next to FIG. 8, an illustration of passing data into a segmentation model is depicted in accordance with an illustrative embodiment. In this figure, components in segmentation model 700 that receive and process inputs are depicted.

As depicted, input intensity image 701 and input mask 702 are input into vision embedding 800. This component receives input images which are in shape [batch size, width, height, channel] and outputs data in shape [batch size, embedding dimension]. These shapes can be a matrix in which a row represents an encoded vector for one sample in the batch. The batch size can refer to the number of samples being processed simultaneously. Embedding dimension is the length of a vector containing the information for the sample.

The output of vision embedding 800 is sent to concatenate 801. Material performance data 711 is input into concatenate 801 in segmentation model 700. In this illustrative example, concatenate 801 operates to the output of vision embedding 800 with material performance data 711. The least two sets of data are combined into a single set of data for further processing. These two sets of data are combined into a single vector and sent to encoder 802.

In this illustrative example, encoder 802 component can be a number of layers such as neural network layers and can implement a transformer architecture. Encoder 802 processes the data and extracts information. For example, encoder 802 can identify patterns and relationships between the image data output by vision embedding and material performance data 711 in the vector combining the concatenation of the state received by encoder 802. This component can output data in a shape [batch size, encoding dimension].

This output from encoder 802 is sent to concatenate 803. Additionally, at least one of platform data 712, preprocessed data 714, or material performance data 711 can be input into segmentation model 700 through concatenate 803. Concatenate 803 combines this data with the output from encoder 802 to form a vector that is sent to segmentation head 804.

In this illustrative example, segmentation head 804 performs a final set of operations and outputs data in shape [batch size, number of classes, mask width, mask height] to form output mask 704. In this example, the number of classes are two classes: an anomalous class for anomaly 703 and a non-anomalous class.

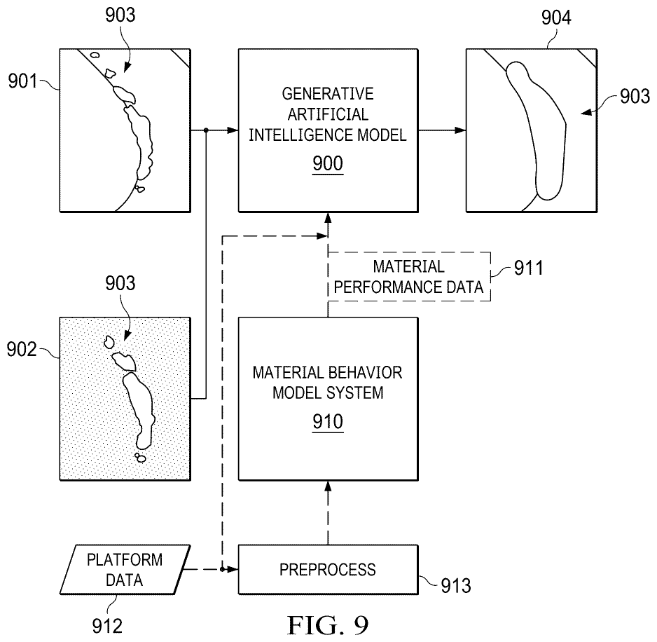

With reference to FIG. 9, an illustration of a generative artificial intelligence model used to generate an output image of a number of parameters predicted for an anomaly is depicted in accordance with an illustrative embodiment. Generative artificial intelligence model 900 is an example model that can be trained by trainer 400 in FIG. 4.

As depicted, input intensity image 901 and input mask 902 at a first time frame are input into generative artificial intelligence model 900. In this example, anomaly 903 is present in input intensity image 901 and input mask 902. In response to these inputs, generative artificial intelligence model 900 outputs output intensity image 904 with anomaly 903 having changes in the number parameters as compared to the number parameters for anomaly 903 in input intensity image 901.

Further, as with segmentation model 700 in FIG. 7, additional inputs can be input into generative artificial intelligence model 900 in addition to input intensity image 901 and input mask 902. Material performance data 911 generated by material behavior model system 910 using platform data 912 is an example of another input that can be used by generative artificial intelligence model 900 to generate output intensity image 904.

Additionally, platform data 912 can be processed by preprocess 913 prior to being sent into material behavior model system 910 to generate material performance data 911. Further, generative artificial intelligence model 900 can directly receive platform data 912 in addition to or in place of material performance data 911. The use of this additional data may help improve the prediction of changes in the number parameters for anomalies.

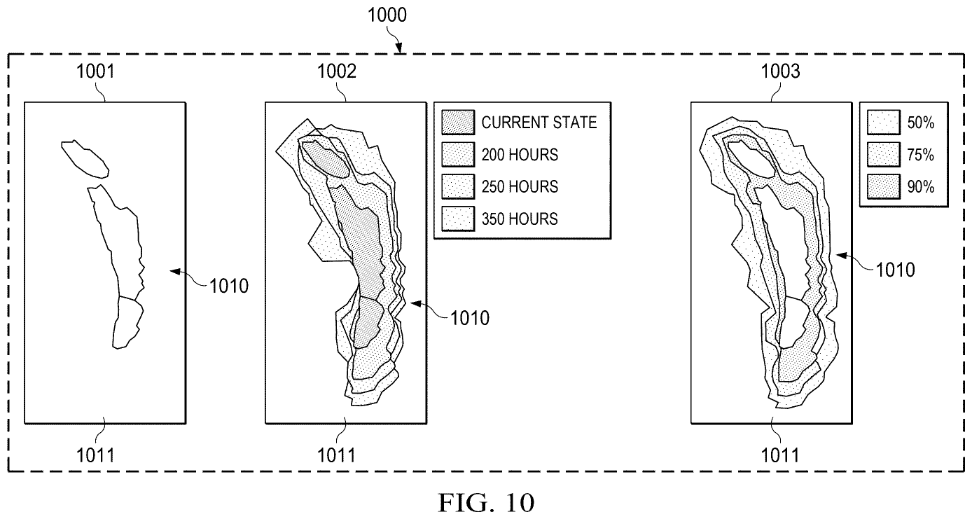

With reference to FIG. 10, an illustration of images for an anomaly is depicted in accordance with an illustrative embodiment. In this example, images 1000 are images for anomaly 1010. Image 1001 is an example of input image 230 in FIG. 2. Image 1002 and image 1003 are examples of output image 235 output by an anomaly analysis system, such as anomaly analysis system 215 in FIG. 2.

Image 1001 is an intensity image of anomaly 1010 on a platform 1011 and a reference time frame. This reference time frame is a time frame from which a prediction of parameters for anomaly 1010 at future time frames can be made. In this example, these parameters can be, for example, an area and shape.

In this illustrative example, image 1002 in images 1000 illustrates a change in anomaly 1010 at different future time frames from the referenced time frame shown in image 1001. As depicted, image 1002 shows the change in anomaly 1010 predicted at 200 flight hours, 250 flight hours, and 350 flight hours. These flight hours are future time frames from referenced time frame in image 1001.

Image 1003 in images 1000 illustrates the probability of anomaly 1010 having a collected change in size after 200 flight hours as a future time frame from the referenced time frame. As depicted, area and shape of anomaly 1010 are shown for a probability of 90%, 75%, and 50%.

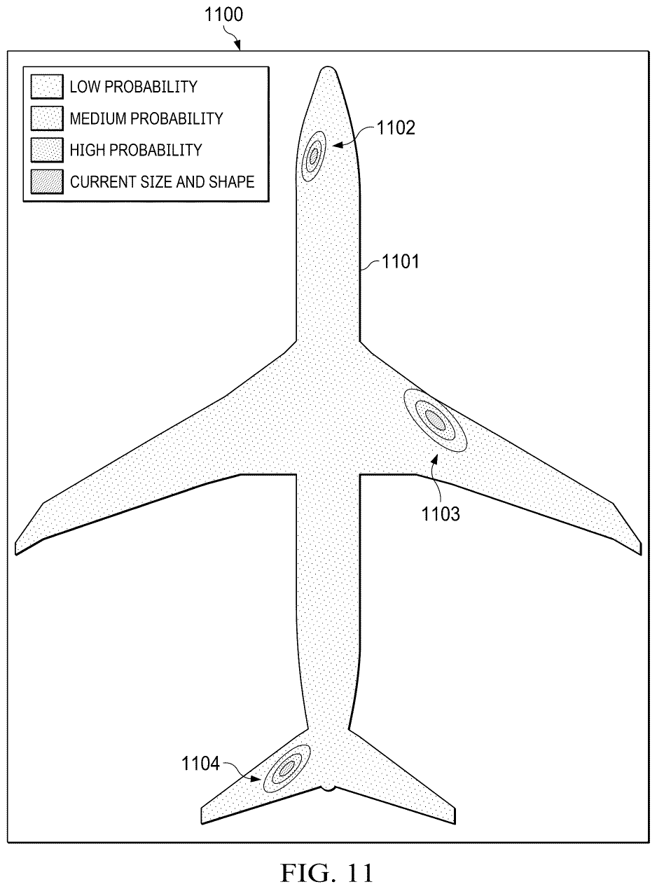

Next in FIG. 11, an illustration of a heat map of an aircraft is depicted in accordance with an illustrative embodiment. As depicted, heat map 1100 is an example of an image generated for aircraft 1101. Heat map 1100 is generated using an anomaly analysis system, such as anomaly analysis system 215 in FIG. 2. Heat map 1100 is an example of output image 235 in FIG. 2.

In this illustrative example, this image is not a photograph of aircraft 1101, but is a rendering of aircraft 1101. In this example, heat map 1100 can be generated using multiple images captured for aircraft 1101. For example, images can be taken of aircraft 1101 by at least one of an unmanned aerial vehicle, a crawler, a human operator using a camera, a fixed camera, or other sensor systems that can capture images of aircraft 1101.

As depicted in heat map 1100, three anomalies, anomaly 1102, anomaly 1103, and anomaly 1104, are shown on aircraft 1101 in heat map 1100.

In the illustrative example, heat map 1100 shows the size and shape of anomaly 1102, anomaly 1103, and anomaly 1104 after 400 flight hours as a future time frame from the current time frame of an image or images used as input.

As depicted, heat map 1100 shows locations of anomalies on aircraft 1101. This heat map also shows a size of the anomalies at a future time frame of 400 flight hours. Further, different sizes are shown for different probabilities at this future time frame in the different locations on aircraft 1101.

The illustration of the images in FIGS. 10 and 11 are represented as an example of one manner in which images can be generated to illustrate a number of parameters predicted for anomalies and future time frames. This illustration is not meant to limit the manner in which other illustrative examples can be implemented.

For example, a three-dimensional image can be displayed to a human operator in which the human operator may navigate and move to different reference points relative to the three-dimensional image to see whether anomalies are present and whether parameters for anomalies may have changed over time. In another example, rather than putting a rendering of an aircraft, an image of the aircraft can be a photograph or actual visual representation with changes made by a machine learning model such as a generative artificial intelligence model, to show changes in parameters for anomalies. In yet another list of examples, these images can be for other types of platforms in addition to an aircraft. For example, images can be for a ship, a spacecraft, a building, or other platform.

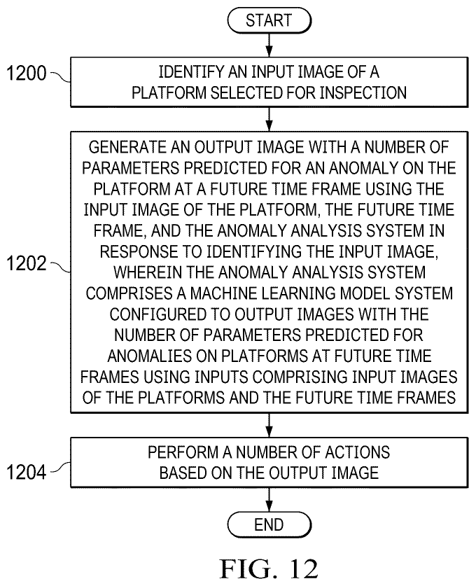

Turning next to FIG. 12, an illustration of a flowchart of a process for predicting an anomaly is depicted in accordance with an illustrative embodiment. The process in FIG. 12 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

The process begins by identifying an input image of a platform selected for inspection (operation 1200). The process generates an output image with a number of parameters predicted for an anomaly on the platform at a future time frame using the input image of the platform, the future time frame, and the anomaly analysis system in response to identifying the input image, wherein the anomaly analysis system comprises a machine learning model system configured to output images with the number of parameters predicted for anomalies on platforms at future time frames using inputs comprising input images of the platforms and the future time frames (operation 1202).

The process performs a number of actions based on the output image (operation 1204). The process terminates thereafter.

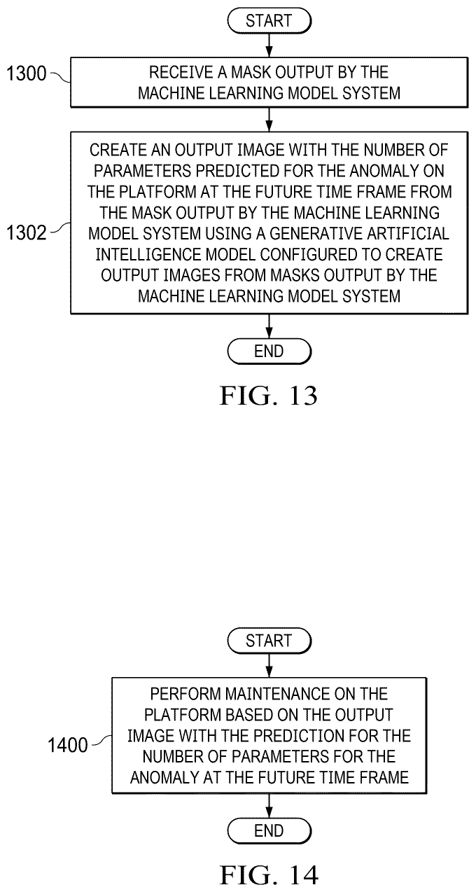

With reference to FIG. 13, an illustration of a flowchart of a process for generating output images from masks is depicted in accordance with an illustrative embodiment. The process in this example is an example of an additional operation that is to be performed with the operations of FIG. 12 and can be implemented in a generative artificial intelligence model, such as generative artificial intelligence model 304 in FIG. 3.

The process receives a mask output by the machine learning model system (operation 1300). The process creates an output image with the number of parameters predicted for the anomaly on the platform at the future time frame from the mask output by the machine learning model system using a generative artificial intelligence model configured to create output images from masks output by the machine learning model system (operation 1302). The process terminates thereafter.

Next in FIG. 14, an illustration of a flowchart of a process for performing maintenance is depicted in accordance with an illustrative embodiment. The process in this flowchart is an example of an additional operation that can be performed with the operations in FIG. 12.

The process performs maintenance on the platform based on the output image with the prediction for the number of parameters for the anomaly at the future time frame (operation 1400). The process terminates thereafter.

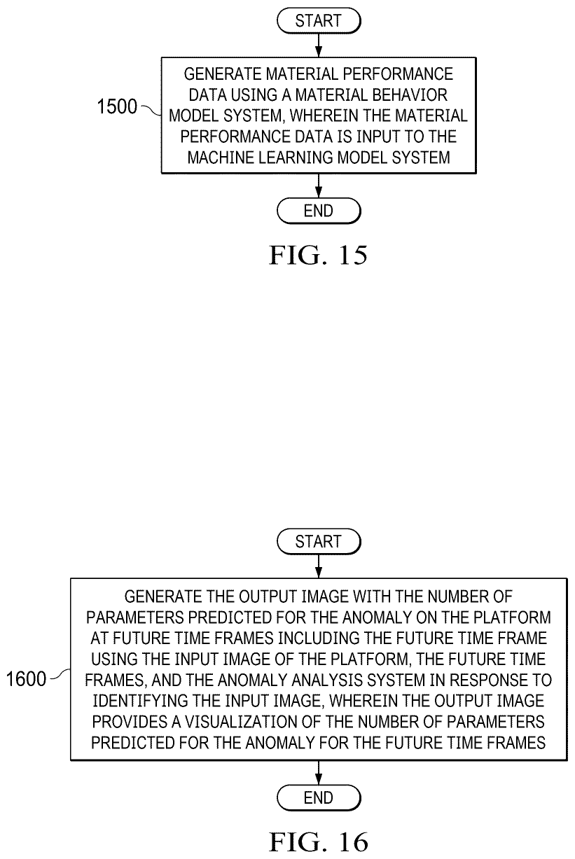

Turning now to FIG. 15, an illustration of a flowchart of a process for generating material performance data is depicted in accordance with an illustrative embodiment. The process in this flowchart is an example of an additional operation that can be performed with the operations in FIG. 12.

The process generates material performance data using a material behavior model system, wherein the material performance data is input to the machine learning model system (operation 1500). The process terminates thereafter.

With reference to FIG. 16, an illustration of a flowchart of a process for generating an output image is depicted in accordance with an illustrative embodiment. The process of this flowchart is an example of an implementation for operation 1202 in FIG. 12.

The process generates the output image with the number of parameters predicted for the anomaly on the platform at future time frames including the future time frame using the input image of the platform, the future time frames, and the anomaly analysis system in response to identifying the input image, wherein the output image provides a visualization of the number of parameters predicted for the anomaly for the future time frames (operation 1600). The process terminates thereafter.

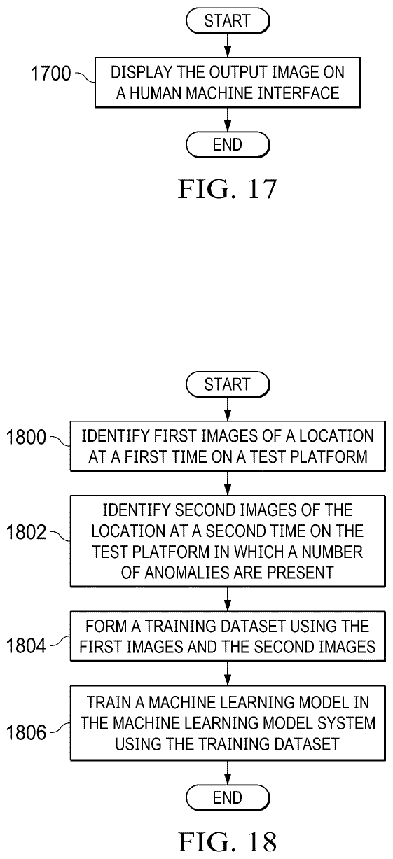

Next in FIG. 17, an illustration of a flowchart of a process for displaying an output image is depicted in accordance with an illustrative embodiment. The process in this flowchart is an example of an additional operation that can be performed with the operations in FIG. 12.

The process displays the output image on a human machine interface (operation 1700). The process terminates thereafter.

Turning now to FIG. 18, an illustration of a flowchart of a process for training a machine learning model is depicted in accordance with an illustrative embodiment. The process in FIG. 18 can be implemented in hardware, software, or both. When implemented in software, the process can take the form of program instructions that are run by one of more processor units located in one or more hardware devices in one or more computer systems. For example, the process can be implemented in trainer 400 in FIG. 4.

The process identifies first images of a location at a first time on a test platform (operation 1800). In operation 1800, the test platform is any platform from which images are generated for use in training. The process identifies second images of the location at a second time on the test platform in which a number of anomalies are present (operation 1802).

The process forms a training dataset using the first images and the second images (operation 1804). The process trains a machine learning model in the machine learning model system using the training dataset (operation 1806). The process terminates thereafter.

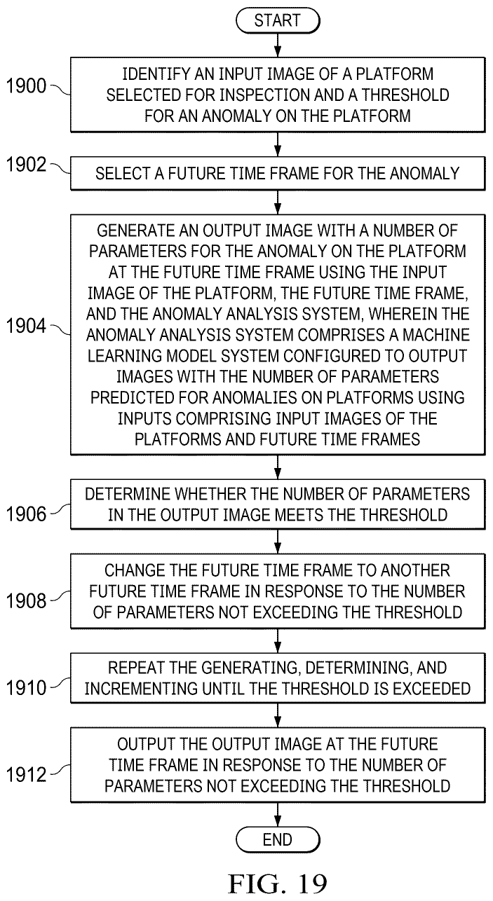

With reference next to FIG. 19, an illustration of a flowchart of a process for predicting an anomaly is depicted in accordance with an illustrative embodiment. The process in FIG. 19 can be implemented in hardware, software, or both. When implemented in software, the process can take the form of program instructions that are run by one of more processor units located in one or more hardware devices in one or more computer systems. For example, the process can be implemented in anomaly predictor 214 in computer system 212 in FIG. 2.

The process begins by identifying an input image of a platform selected for inspection and a threshold for an anomaly on the platform (operation 1900). The process selects a future time frame for the anomaly (operation 1902). The process generates an output image with a number of parameters for the anomaly on the platform at the future time frame using the input image of the platform, the future time frame, and the anomaly analysis system, wherein the anomaly analysis system comprises a machine learning model system configured to output images with the number of parameters predicted for anomalies on platforms using inputs comprising input images of the platforms and future time frames (operation 1904).

The process determines whether the number of parameters in the output image meets the threshold (operation 1906). The process changes the future time frame to another future time frame in response to the number of parameters not exceeding the threshold (operation 1908).

In operation 1908, the future time frame is changed using one of a linear search and a binary search. A linear search involves incrementing the threshold by some selected amount. For example, the future time frame can be incremented by one flight hour, ten flight hours, or some other number of flight hours.

With a binary search, the search begins by selecting an initial future time frame. This initial future time frame can be in the middle of a possible range of time frames. For example, the future time frame can be the midpoint between zero and the maximum possible value for the future time frame. The possible range is divided in half for the selected future time frame. The selected future time frame is evaluated to determine whether the threshold for the number of parameters is exceeded. If the future time frame results in a number of parameters exceeding the threshold, the lower half of the remaining range is searched in the same manner. If the future time frame does not result in the number of parameters exceeding the threshold, the upper half of the remaining range is searched. These steps are repeated until a future time frame is found that matches the threshold within an acceptable margin.

The process repeats the generating, determining, and incrementing until the threshold is exceeded (operation 1910). The process outputs the output image at the future time frame in response to the number of parameters not exceeding the threshold (operation 1912). The process terminates thereafter.

Thus, with the process in FIG. 19, output images can be generated that provides identifying a future time frame in which the anomaly becomes out of tolerance. For example, a threshold of a 50% growth in the area of an anomaly can be set. With this process, the future time frame can be identified when the anomaly grows by 50%. Thus, a future time frame such as the number of hours until maintenance can be determined.

By knowing this future time frame, maintenance can be scheduled proactively a time that is convenient. With the ability to determine when maintenance is needed sooner, as compared to current inspection techniques, the amount of time a platform such as an aircraft will be out of service at an undesired time can be reduced.

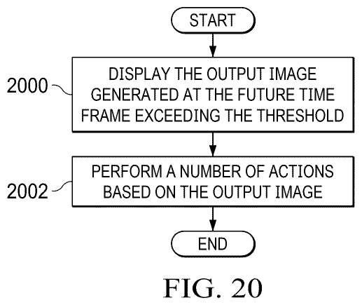

Turning next to FIG. 20, an illustration of a flowchart of a process for performing actions is depicted in accordance with an illustrative embodiment. This flowchart is an example of additional operations that can be performed with the operations in FIG. 19.

The process displays the output image generated at the future time frame exceeding the threshold (operation 2000). The process performs a number of actions based on the output image (operation 2002). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

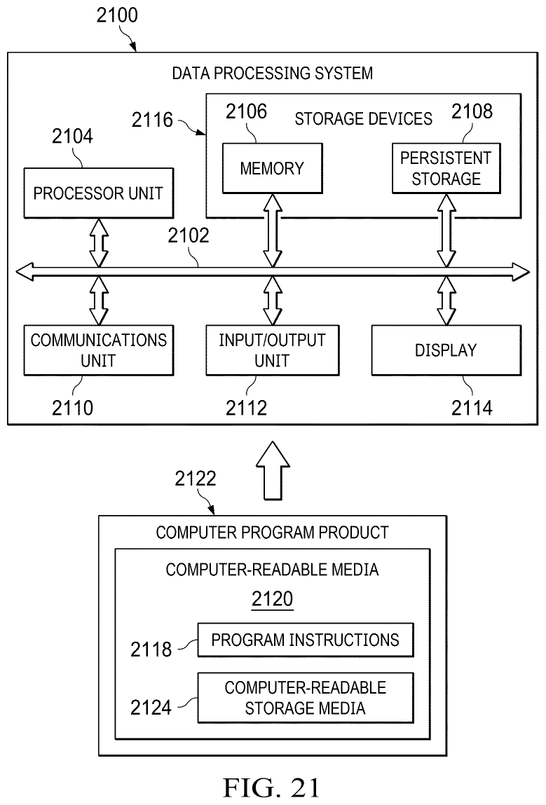

Turning now to FIG. 21, an illustration of a block diagram of a data processing system is depicted in accordance with an illustrative embodiment. Data processing system 2100 can be used to implement computer 105 in FIG. 1. Data processing system 2100 can also be used to implement computer system 212 in FIG. 2. In this illustrative example, data processing system 2100 includes communications framework 2102, which provides communications between processor unit 2104, memory 2106, persistent storage 2108, communications unit 2110, input/output (I/O) unit 2112, and display 2114. In this example, communications framework 2102 takes the form of a bus system.

Processor unit 2104 serves to execute instructions for software that can be loaded into memory 2106. Processor unit 2104 includes one or more processors. For example, processor unit 2104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2104 can be implemented using one or more heterogeneous processor systems in which a main processor is present with secondary processors on a single chip. As another illustrative example, processor unit 2104 can be a symmetric multi-processor system containing multiple processors of the same type on a single chip.

Memory 2106 and persistent storage 2108 are examples of storage devices 2116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 2116 may also be referred to as computer-readable storage devices in these illustrative examples. Memory 2106, in these examples, can be, for example, a random-access memory or any other suitable volatile or non-volatile storage device. Persistent storage 2108 may take various forms, depending on the particular implementation.

For example, persistent storage 2108 may contain one or more components or devices. For example, persistent storage 2108 can be a hard drive, a solid-state drive (SSD), a flash memory, a rewritable optical disk, a rewritable magnetic tape, or some combination of the above. The media used by persistent storage 2108 also can be removable. For example, a removable hard drive can be used for persistent storage 2108.

Communications unit 2110, in these illustrative examples, provides for communications with other data processing systems or devices. In these illustrative examples, communications unit 2110 is a network interface card.

Input/output unit 2112 allows for input and output of data with other devices that can be connected to data processing system 2100. For example, input/output unit 2112 may provide a connection for user input through at least one of a keyboard, a mouse, or some other suitable input device. Further, input/output unit 2112 may send output to a printer. Display 2114 provides a mechanism to display information to a user.

Instructions for at least one of the operating system, applications, or programs can be located in storage devices 2116, which are in communication with processor unit 2104 through communications framework 2102. The processes of the different embodiments can be performed by processor unit 2104 using computer-implemented instructions, which may be located in a memory, such as memory 2106.

These instructions are referred to as program instructions, computer usable program instructions, or computer-readable program instructions that can be read and executed by a processor in processor unit 2104. The program instructions in the different embodiments can be embodied on different physical or computer-readable storage media, such as memory 2106 or persistent storage 2108.

Program instructions 2118 are located in a functional form on computer-readable media 2120 that is selectively removable and can be loaded onto or transferred to data processing system 2100 for execution by processor unit 2104. Program instructions 2118 and computer-readable media 2120 form computer program product 2122 in these illustrative examples. In the illustrative example, computer-readable media 2120 is computer-readable storage media 2124.

Computer-readable storage media 2124 is a physical or tangible storage device used to store program instructions 2118 rather than a medium that propagates or transmits program instructions 2118. Computer-readable storage media 2124 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 2124, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 2118 can be transferred to data processing system 2100 using a computer-readable signal media. The computer-readable signal media are signals and can be, for example, a propagated data signal containing program instructions 2118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 2120” can be singular or plural. For example, program instructions 2118 can be located in computer-readable media 2120 in the form of a single storage device or system. In another example, program instructions 2118 can be located in computer-readable media 2120 that is distributed in multiple data processing systems. In other words, some instructions in program instructions 2118 can be located in one data processing system while other instructions in program instructions 2118 can be located in one data processing system. For example, a portion of program instructions 2118 can be located in computer-readable media 2120 in a server computer while another portion of program instructions 2118 can be located in computer-readable media 2120 located in a set of client computers.

The different components illustrated for data processing system 2100 are not meant to provide architectural limitations to the manner in which different embodiments can be implemented. In some illustrative examples, one or more of the components may be incorporated in or otherwise form a portion of, another component. For example, memory 2106, or portions thereof, may be incorporated in processor unit 2104 in some illustrative examples. The different illustrative embodiments can be implemented in a data processing system including components in addition to or in place of those illustrated for data processing system 2100. Other components shown in FIG. 21 can be varied from the illustrative examples shown. The different embodiments can be implemented using any hardware device or system capable of running program instructions 2118.

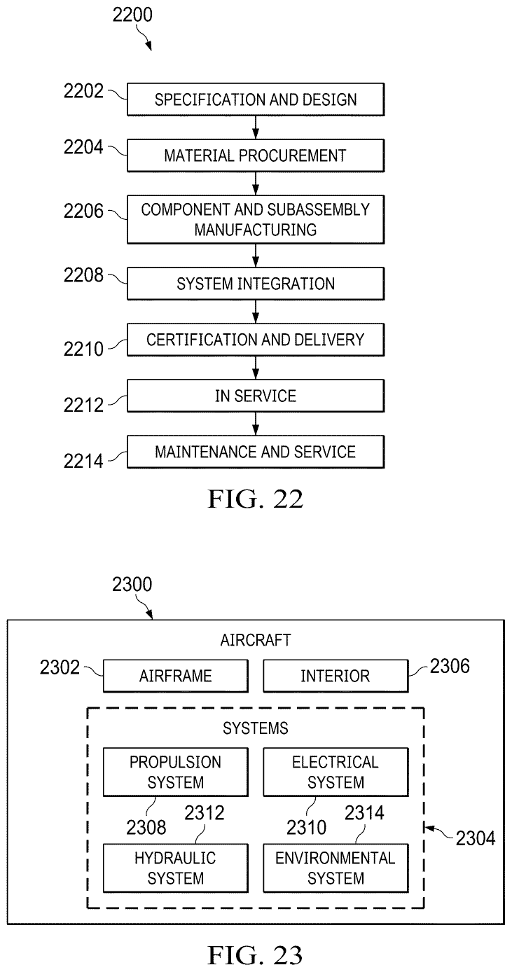

Illustrative embodiments of the disclosure may be described in the context of aircraft manufacturing and service method 2200 as shown in FIG. 22 and aircraft 2300 as shown in FIG. 23. Turning first to FIG. 22, an illustration of a block diagram of an aircraft manufacturing and service method is depicted in accordance with an illustrative embodiment. During pre-production, aircraft manufacturing and service method 2200 may include specification and design 2202 of aircraft 2300 in FIG. 23 and material procurement 2204.

During production, component and subassembly manufacturing 2206 and system integration 2208 of aircraft 2300 in FIG. 23 takes place. Thereafter, aircraft 2300 in FIG. 23 can go through certification and delivery 2210 in order to be placed in service 2212. While in service 2212 by a customer, aircraft 2300 in FIG. 23 is scheduled for routine maintenance and service 2214, which may include modification, reconfiguration, refurbishment, and other maintenance or service.

Each of the processes of aircraft manufacturing and service method 2200 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 23, an illustration of a block diagram of an aircraft is depicted in which an illustrative embodiment may be implemented. In this example, aircraft 2300 is produced by aircraft manufacturing and service method 2200 in FIG. 22 and may include airframe 2302 with plurality of systems 2304 and interior 2306. Examples of systems 2304 include one or more of propulsion system 2308, electrical system 2310, hydraulic system 2312, and environmental system 2314. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 2200 in FIG. 22.

In one illustrative example, components or subassemblies produced in component and subassembly manufacturing 2206 in FIG. 22 can be fabricated or manufactured in a manner similar to components or subassemblies produced while aircraft 2300 is in service 2212 in FIG. 22. As yet another example, one or more apparatus embodiments, method embodiments, or a combination thereof can be utilized during production stages, such as component and subassembly manufacturing 2206 and system integration 2208 in FIG. 22. One or more apparatus embodiments, method embodiments, or a combination thereof may be utilized while aircraft 2300 is in service 2212, during maintenance and service 2214 in FIG. 22, or both. The use of a number of the different illustrative embodiments may substantially expedite the assembly of aircraft 2300, reduce the cost of aircraft 2300, or both expedite the assembly of aircraft 2300 and reduce the cost of aircraft 2300.

For example, anomaly prediction system 202 in FIG. 2 can be used during at least one of in-service 2212 or maintenance and service 2214 to determine whether maintenance is needed for aircraft 2300. In this manner, maintenance can be determined more accurately and with more time to schedule maintenance for aircraft 2300. As a result, unexpected maintenance can occur less often resulting in aircraft 2300 being in service with more predictability.

Thus, the illustrative examples provided a method, apparatus, system, and computer program product for predicting anomalies at future time frames. In one illustrative example, a method predicts an anomaly. An input image of a platform selected for inspection is identified. An output image with a number of parameters predicted for an anomaly on the platform at a future time frame is generated using the input image of the platform, the future time frame, and an anomaly analysis system in response to identifying the input image. The anomaly analysis system comprises a machine learning model system configured to output images with the number of parameters predicted for anomalies on platforms at future time frames using inputs comprising input images of the platforms and the future time frames. A number of actions is performed based on the output image.

Thus, the illustrative examples can predict locations of anomalies over time. In particular, for example, a prediction of a number of parameters for anomalies at a future time frame can be predicted. In these examples, the number of parameters that can be predicted for future time frames can be used to determine how these anomalies may grow, move, propagate, or otherwise change over time.

In these illustrative examples, visualizations in the form of images of parameters for anomalies at future time frames can be output from an anomaly analysis system for use in determining actions that may be performed in response to the generation of these images. For example, these images can be analyzed by at least one of a computer processor person to determine whether the anomalies at future time frames are out of tolerance and require some action. These visualizations can take a number of forms as described above. For example, the visualizations can be output images in the form of masks, intensity images, heat maps, or other types of visualizations.

The predictions for future states of anomalies at future time frames can be used to determine when to perform maintenance on aircraft or other platforms. These predictions can determine when maintenance is needed accurately and with more fidelity as compared to normal maintenance schedules. Thus, the illustrative examples provide a practical application for predicting future states of anomalies.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An anomaly prediction system comprising:
a computer system; and
an anomaly analysis system in the computer system, wherein the anomaly analysis system comprises:
a machine learning model system configured to output images with a number of parameters predicted for anomalies on platforms at future time frames using inputs comprising input images of the platforms and the future time frames; and
an anomaly predictor in the computer system, wherein the anomaly predictor is configured to perform operations comprising:
identifying an input image of a platform selected for inspection;
generating an output image with the number of parameters for an anomaly on the platform at a future time frame using the input image of the platform, the future time frame, and the anomaly analysis system in response to identifying the input image; and
performing a number of actions based on the output image.

2. The anomaly prediction system of claim 1, wherein the number of actions comprises at least one of storing the output image, generating an alert in response to the output image for the number of parameters predicted for the anomaly at the future time frame being out of a tolerance, scheduling maintenance for the platform, displaying the output image, or sending an email message with the output image.

3. The anomaly prediction system of claim 1, wherein the machine learning model system outputs images in a form of masks wherein the anomaly analysis system further comprises:
a generative artificial intelligence model that is configured to create the output image from a mask output by the machine learning model system.

4. The anomaly prediction system of claim 1 further comprising:
a sensor system configured to generate the input image.

5. The anomaly prediction system of claim 1, wherein maintenance is performed on the platform based on the output image with the number of parameters predicted for the anomaly at the future time frame.

6. The anomaly prediction system of claim 1, wherein the anomaly analysis system further comprises:
a material behavior model system configured to output material performance data as an input to the machine learning model system.

7. The anomaly prediction system of claim 1, wherein in generating the output image, the anomaly predictor is configured to perform operations comprising:
generating the output image with the number of parameters predicted for the anomaly on the platform at future time frames including the future time frame using the input image of the platform, the future time frames, and the anomaly analysis system in response to identifying the input image, wherein the output image provides a visualization of the number of parameters predicted for the anomaly for the future time frames.

8. The anomaly prediction system of claim 1, wherein the output image is a heat map indicating a size of the anomaly for different probabilities.

9. The anomaly prediction system of claim 1, wherein the anomaly predictor predicts the number of parameters for a number of anomalies in addition to the anomaly to form a plurality of anomalies for the future time frame, wherein the output image is a heat map indicating locations of the plurality of anomalies at the future time frame.

10. The anomaly prediction system of claim 1, wherein the anomaly predictor predicts the number of parameters for a number of anomalies in addition to the anomaly to form a plurality of anomalies for the future time frame, wherein the output image is a heat map indicating a size of each of a plurality of anomalies at the future time frame.

11. The anomaly prediction system of claim 1, wherein the anomaly predictor is configured to perform the operations further comprising:
displaying the output image on a human machine interface.

12. The anomaly prediction system of claim 1, wherein the output image is selected from a group comprising a mask, a color image, and a gray scale image.

13. The anomaly prediction system of claim 1, wherein the inputs to the machine learning model system further comprise platform data.

14. The anomaly prediction system of claim 13, wherein the platform data comprises at least one of weather data, platform telemetry, temperature, a pressure, an acceleration, an engine temperature, a hydraulic pressure, a vibration, a tail number, maintenance data, a pilot identification, flight hours, engine cycles, flight cycles, and route information.

15. The anomaly prediction system of claim 1, wherein the output image provides a visualization of the anomaly based on probabilities for anomaly sizes.

16. The anomaly prediction system of claim 1 further comprising:
a trainer configured to perform training operation comprising:
identifying first images of locations at first times on a test platform;
identifying second images of the locations at second times on the test platform in which a number of anomalies are present;
forming a training dataset using the first images and the second images; and
training a machine learning model in the machine learning model system using the training dataset.

17. The anomaly prediction system of claim 16, wherein the training dataset further comprises at least one of material performance data or platform data.

18. The anomaly prediction system of claim 1, wherein the test platform can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, an unmanned aerial vehicle, an artificial intelligence controlled drone, a surface ship, a tank, a personnel carrier, a train, a spacecraft, a space station, a satellite, a high altitude platform system (HAPS), a submarine, an automobile, a power plant, a bridge, a dam, a house, a manufacturing facility, and a building.

19. An anomaly prediction system comprising:
a computer system;
an anomaly analysis system in the computer system, wherein the anomaly analysis system comprises:
a machine learning model system configured to output images with a number of parameters predicted for anomalies on platforms at future time frames using inputs comprising input images of the platforms and future time frames and;
an anomaly predictor in the computer system, wherein the anomaly predictor is configured to perform operations comprising:
identifying an input image of a platform selected for inspection and a threshold for an anomaly on the platform;
selecting a future time frame for the anomaly;
generating an output image with the number of parameters for the anomaly on the platform at the future time frame using the input image of the platform, the future time frame and the anomaly analysis system;
determining whether the number of parameters in the output image meets the threshold;
changing the future time frame to another future frame in response to the number of parameters not exceeding the threshold;
repeating the generating, determining, and incrementing until the threshold is exceeded; and
outputting the output image at the future time frame in response to the number of parameters not exceeding the threshold.

20. The anomaly prediction system of claim 19, wherein the future time frame is changed using one of a linear search and a binary search.

21. The anomaly prediction system of claim 19, wherein the anomaly predictor is configured to perform operations further comprising:
displaying the output image generated at the future time frame exceeding the threshold; and
performing a number of actions based on the output image.

22. A method for predicting an anomaly, the method comprising:
identifying an input image of a platform selected for inspection;
generating an output image with a number of parameters predicted for the anomaly on the platform at a future time frame using the input image of the platform, the future time frame, and an anomaly analysis system in response to identifying the input image, wherein the anomaly analysis system comprises a machine learning model system configured to output images with the number of parameters predicted for anomalies on platforms at future time frames using inputs comprising input images of the platforms and the future time frames; and
performing a number of actions based on the output image.

23. The method of claim 22, wherein the number of actions comprises at least one of storing the output image, generating an alert in response to the output image for the number of parameters predicted for the anomaly at the future time frame being out of a tolerance, scheduling maintenance for the platform, displaying the output image, or sending an email message with the output image.

24. The method of claim 22, wherein generating the output image comprises:
receiving a mask output by the machine learning model system; and
creating an output image with the number of parameters predicted for the anomaly on the platform at the future time frame from the mask output by the machine learning model system using a generative artificial intelligence model is configured to create output images from masks output by the machine learning model system.

25. The method of claim 22 further comprising:
performing maintenance on the platform based on the output image with the prediction for the number of parameters for the anomaly at the future time frame.

26. The method of claim 22 further comprising:
generating material performance data using a material behavior model system, wherein the material performance data is an input to the machine learning model system.

27. The method of claim 22, wherein generating the output image comprises:
generating the output image with the number of parameters predicted for the anomaly on the platform at future time frames including the future time frame using the input image of the platform, the future time frames, and the anomaly analysis system in response to identifying the input image, wherein the output image provides a visualization of the number of parameters predicted for the anomaly for the future time frames.

28. The method of claim 22 further comprising:
displaying the output image on a human machine interface.

29. The method of claim 22 further comprising:
identifying first images of a location at a first time on a test platform;
identifying second images of the location at a second time on the test platform in which a number of anomalies are present;
forming a training dataset using the first images and the second images; and
training a machine learning model in the machine learning model system using the training dataset.

30. A method for predicting an anomaly, the method comprising:
identifying an input image of a platform selected for inspection and a threshold for the anomaly on the platform;
selecting a future time frame for the anomaly;
generating an output image with a number of parameters for the anomaly on the platform at the future time frame using the input image of the platform, the future time frame and an anomaly analysis system, wherein the anomaly analysis system comprises a machine learning model system configured to output images with the number of parameters predicted for anomalies on platforms using inputs comprising input images of the platforms and future time frames;
determining whether the number of parameters in the output image meets a threshold;
changing the future time frame to another future frame in response to the number of parameters not exceeding the threshold;
repeating the generating, determining, and incrementing until the threshold is exceeded; and
outputting the output image at the future time frame in response to the number of parameters not exceeding the threshold.

31. The method of claim 30, wherein the future time frame is changed using one of a linear search and a binary search.

32. The method of claim 30 further comprising:
displaying the output image generated at the future time frame exceeding the threshold; and
performing a number of actions based on the output image.

33. A computer program product for predicting an anomaly, the computer program product comprising:
a set of one or more computer-readable storage media;
program instructions stored on the set of one or more storage media to perform operations comprising:
identifying an input image of a platform selected for inspection;
generating an output image with a number of parameters predicted for the anomaly on the platform at a future time frame using the input image of the platform, the future time frame, and an anomaly analysis system in response to identifying the input image, wherein the anomaly analysis system comprises a machine learning model system configured to output images with the number of parameters predicted for anomalies on platforms at future time frames using inputs comprising input images of the platforms and the future time frames; and
performing a number of actions based on the output image.
